(19) United States
(12) Patent Application Publication
(10) Pub. No.: US 2026/0351683 A1
(43) Pub. Date: Nov. 5, 2026

(54) ELECTRODE LAMINATE MODULE AND METHOD FOR MANUFACTURING BIPOLAR ELECTRODE LAMINATE MODULE

(71) Applicant: TOYOTA JIDOSHA KABUSHIKI KAISHA, Toyota-shi (JP)

(72) Inventor: Ruri HARA, Toyota-shi (JP)

(73) Assignee: TOYOTA JIDOSHA KABUSHIKI KAISHA, Toyota-shi (JP)

(21) Appl. No.: 19/643,997

(22) Filed: Apr. 10, 2026

(30) Foreign Application Priority Data
May 1, 2025 (JP) 2025-076202

(51) Int. Cl. H01M 10/0585

(52) U.S. Cl. CPC H01M 10/0585

(57) ABSTRACT

An object of the present disclosure is to provide an electrode laminate module in which an electrode laminate and a current collector plate are satisfactorily electrically connected. In the electrode laminate module of the present disclosure, a first restraint plate, a first current collector plate, one or more bipolar electrode laminates, a second current collector plate, and a second restraint plate are laminated in this order, between the first current collector plate and the bipolar electrode laminate, between two of the bipolar electrode laminates adjacent, and/or between the bipolar electrode laminate and the second current collector plate, an elastic body layer with metal foil is laminated, and the metal foil on the upper surface of the elastic body and the metal foil on the lower surface of the elastic body are electrically connected to each other.

### FIELD

The present disclosure relates to an electrode laminate module and a method of manufacturing a bipolar electrode laminate.

### BACKGROUND

An electrode laminate module is one in which an electrode laminate comprising a positive electrode current collector layer, a positive electrode active material layer, a solid electrolyte layer or a separator layer, a negative electrode active material layer, and a negative electrode current collector layer in this order is housed in a sealing body or the like.

For example, PTL 1 discloses a restraint jig used at the time of manufacturing a power storage module including a plurality of electrodes, and configured to restrain, in a laminating direction, a laminate in which the electrodes are laminated in a first direction, the restraint jig comprising: a pair of restraint members disposed at both ends in the first direction of the laminate; and a pair of regulation members disposed at both ends in a second direction intersecting with the first direction of a held body configured to include the laminate and the pair of restraint members, wherein each of the pair of regulation members includes a pair of contact parts configured to be brought into contact from an outer side in the first direction with respective edges of the pair of restraint members arranged in the first direction to hold the laminate therebetween, and a connection part configured to connect the pair of contact parts, a size of the regulation member in a third direction orthogonal to both of the first direction and the second direction is equal to or larger than a size of the laminate in the third direction, a plurality of through holes passing through both of the pair of contact parts and the pair of restraint members in the first direction are formed on the pair of contact parts and the pair of restraint members in plain view viewed from the first direction in a state in which the pair of regulation members holds the held body therebetween, and relative positions of the pair of regulation members with respect to the pair of restraint members are fixed by insertion members inserted into the respective through holes in a state in which the pair of regulation members holds the held body therebetween. According to the restraint jig described in PTL 1, it is considered that the stack of the electrodes stacked in the first direction can be restrained easily, at the time of manufacturing the power storage module.

Further, PTL 2 discloses a method of manufacturing a storage battery device, comprising: an arrangement step wherein sandwiching the one or a plurality of power storage modules configured to include a stack of bipolar electrodes in the stacking direction of the laminates by a pair of restraint plates, and a restraining step wherein fastening the edge of the pair of restraint plates by a fastening member to add a restraining load in the stacking direction to the power storage module, wherein in the arrangement step, an one surface of the restraint plate having a curved surface provided in a convex curved is arranged so as to face the power storage module side, in the restraining step, the one surface of the restraint plate is flattened by fastening of the fastening member. According to the method described in PTL 2, it is considered that a uniform restraining load can be added to a power storage module while avoiding an increase in body size and weight.

### CITATION LIST

### Patent Literature

[PTL 1] Japanese Unexamined Patent Publication No. 2023-030551
[PTL 2] Japanese Unexamined Patent Publication No. 2019-216073

### SUMMARY

### Technical Problem

As an electrode laminate module, it can be considered a configuration in which a plurality of bipolar electrode laminates is stacked to each other, current collector plates are arranged respectively on the upper surface and lower surface thereof, further on the upper surface and lower surface thereof, the restraint plates are arranged. In this case, the electrode laminate and the current collector plate, and/or two electrode laminates adjacent to each other are electrically connected to each other. However, in such a case, there is a risk that the electrical connection becomes unstable.

It is therefore an object of the present disclosure to provide an electrode laminate module in which an electrode laminate and a current collector plate are satisfactorily electrically connected.

### Solution to Problem

The present disclosure achieves the object described above by the following means.

### <Aspect 1>

An electrode laminate module,
wherein a first restraint plate, a first current collector plate, one or more bipolar electrode laminates, a second current collector plate, and a second restraint plate are laminated in this order,
wherein between the first current collector plate and the bipolar electrode laminate, between two of the bipolar electrode laminates adjacent, and/or between the bipolar electrode laminate and the second current collector plate, an elastic body layer with metal foil is laminated,
wherein, by means of the first and second restraint plates, the first and second current collector plates, the one or more bipolar electrode laminates, and the elastic body layer are restrained in the laminating direction,
wherein the bipolar electrode laminate has a positive electrode current collector layer, a positive electrode active material layer, a solid electrolyte layer or a separator layer, a negative electrode active material layer, and a negative electrode current collector layer in this order, and
wherein the elastic body layer has an elastic body and a metal foil on at least a portion of the upper surface, the lower surface, and the side surface of the elastic body, whereby the metal foil on the upper surface of the elastic body and the metal foil on the lower surface of the elastic body are electrically connected to each other.

### <Aspect 2>

The electrode laminate module according to aspect 1,
wherein the elastic body is composed of a plurality of elastic sub-bodies arranged in a plane direction, and
wherein the metal foil enfolds the plurality of elastic sub-bodies as a whole, whereby the metal foil on the upper surface of the elastic body and the metal foil on the lower surface of the elastic body are electrically connected to each other.

### <Aspect 3>

The electrode laminate module according to aspect 2,
wherein the plurality of elastic sub-bodies has an engaging portion at an end portion, and
wherein the engaging portions of the adjacent elastic sub-bodies are engaged with each other, whereby the plurality of elastic sub-bodies is integrated to constitute the elastic body.

### <Aspect 4>

The electrode laminate module according to aspect 3,
wherein the engaging portion has an uneven portion on the surface, and
wherein the uneven portions of the engaging portions of the adjacent elastic sub-bodies are engaged with each other, whereby the plurality of elastic sub-bodies is integrated to constitute the elastic body.

### <Aspect 5>

A method of manufacturing a bipolar electrode laminate, wherein the method comprises:
providing the electrode laminate module of any one of aspects 1-4, and
applying a voltage to the first current collector plate and the second current collector plate to charge or discharge the bipolar electrode laminate.

### Advantageous Effects of Invention

According to the method of the present disclosure, it is possible to provide an electrode laminate module in which the electrode laminate and the current collector plate are satisfactorily electrically connected.

### BRIEF DESCRIPTION OF DRAWINGS

FIG. 1 is a schematic diagram for describing one embodiment of the present disclosure.

FIG. 2 is a schematic diagram for describing one embodiment of the present disclosure.

FIG. 3 is a schematic diagram for explaining an example of the present disclosure.

FIG. 4 is a schematic diagram for explaining an example of the present disclosure.

### DESCRIPTION OF EMBODIMENTS

Hereinafter, embodiments of the present disclosure will be described in detail. The present disclosure is not limited to the following embodiments, and can be variously modified and implemented within the scope of the gist of the present disclosure. In addition, in the description of the drawings, the same elements are denoted by the same reference signs, and redundant description thereof will be omitted.

### <<Electrode Laminate Module>>

In the electrode laminate module of the present disclosure,
a first restraint plate, a first current collector plate, one or more bipolar electrode laminates, a second current collector plate, and a second restraint plate are laminated in this order,
between the first current collector plate and the bipolar electrode laminate, between two of the bipolar electrode laminates adjacent, and/or between the bipolar electrode laminate and the second current collector plate, an elastic body layer with metal foil is laminated,
by means of the first and second restraint plates, the first and second current collector plates, the one or more bipolar electrode laminates, and the elastic body layer are restrained in the laminating direction,
the bipolar electrode laminate has a positive electrode current collector layer, a positive electrode active material layer, a solid electrolyte layer or a separator layer, a negative electrode active material layer, and a negative electrode current collector layer in this order, and
the elastic body layer has an elastic body and a metal foil on at least a portion of the upper surface, the lower surface, and the side surface of the elastic body, whereby the metal foil on the upper surface of the elastic body and the metal foil on the lower surface of the elastic body are electrically connected to each other.

According to the above electrode laminate module, between the electrode laminate and the current collector plate, and/or between the two electrode laminates can be satisfactorily electrically connected.

As an electrode laminate module, it can be considered a configuration in which a plurality of bipolar electrode laminates is laminated to each other, current collector plates are arranged respectively on the upper surface and lower surface thereof, further on the upper surface and lower surface thereof, the restraint plates are arranged. In this case, the electrode laminate and the current collector plate, and/or two electrode laminates adjacent to each other are electrically connected to each other. However, in such a case, there is a risk that the electrical connection will become unstable.

In contrast, the electrode laminate module of the present disclosure has an elastic body layer with metal foil laminated between the first current collector plate and the bipolar electrode laminate, between the adjacent two bipolar electrode laminates, and/or between the bipolar electrode laminate and the second current collector plate, and the metal foil on the upper surface of the elastic body and the lower surface of the elastic body are electrically connected to each other to bring metal foils on the upper surface of the elastic body and the lower surface of the elastic body into close contact with the adjacent current collector plates and/or the bipolar electrode laminate, whereby it can improve electrical connection between the first current collector plate and the bipolar electrode laminate, between the adjacent two bipolar electrode laminates, and/or between the bipolar electrode laminate and the second current collector plate.

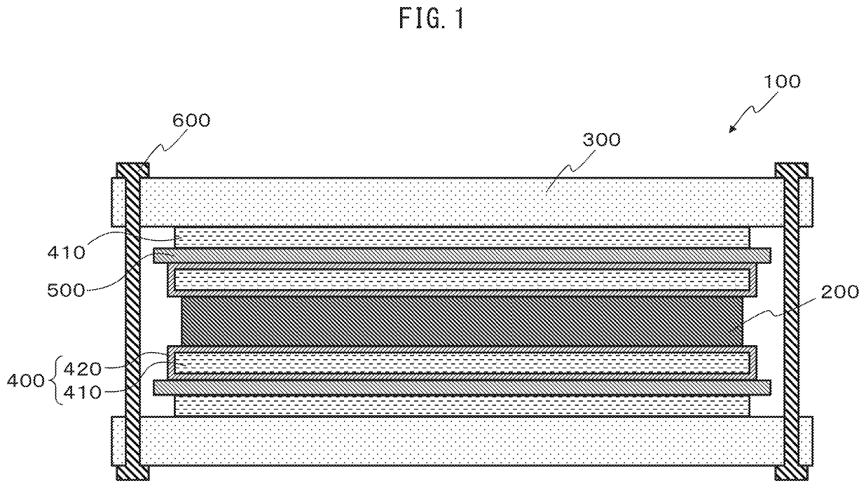

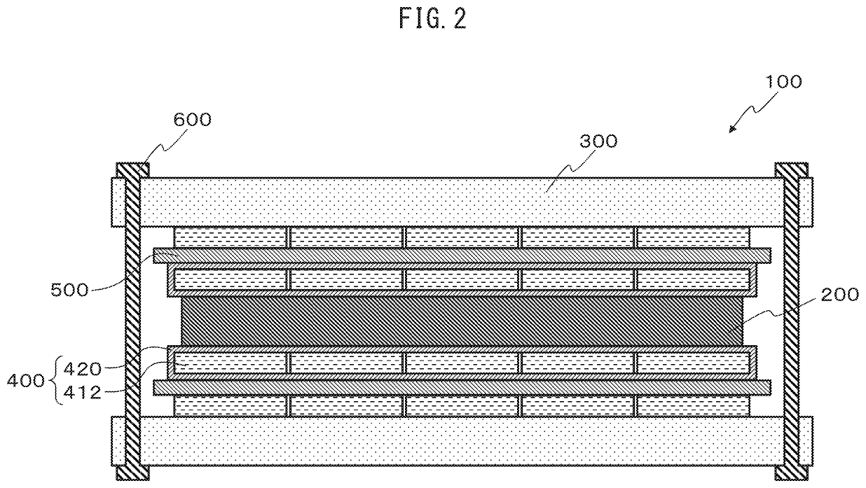

Embodiments in the present disclosure are shown in FIGS. 1 and 2. The electrode laminate module 100 of one embodiment of the present disclosure shown in FIG. 1 includes a first restraint plate 300, an insulating elastic body layer 410, a first current collector plate 500, an elastic body layer 400 with a metal foil 420, a bipolar electrode laminate 200, an elastic body layer 400 with a metal foil 420, a second current collector plate 500, an insulating elastic body layer 410 and a second restraint plate 300 in this order. The first restraint plate 300 and the second restraint plate 300 are restrained by the restraint member 600 to pressurize in the laminating direction.

Also, an electrode laminate module of another embodiment of the present disclosure is shown in FIG. 2. Insulating elastic body layer 410 and the elastic body layer 400 with the metal foil 420 of the electrode laminate module 100 shown in FIG. 2 are composed of a plurality of elastic sub-bodies 412. When the area of the electrode laminate module is large, by constituting the elastic body layer by a plurality of elastic sub-bodies in this manner, it can be easily manufactured, and thus is preferable.

In the present disclosure, the restraining pressure (surface pressure) imposed on the elastic body layers restrained by the first and second restraint plates is not particularly limited, but may be 0.010 MPa or greater, 0.020 MPa or greater, or 0.040 MPa or greater, and may be 0.500 MPa or less, 0.400 MPa or less, or 0.300 MPa or less.

### <First and Second Restraint Plates>

In the present disclosure, the first and second restraint plates are included in the electrode laminate module, and by the first and second restraint plates, the first and second current collector plates, the one or more bipolar electrode laminates, and the elastic body layer are restrained in the laminating direction. The restraint plate can be formed of any material, can be constructed of an insulating material or be constructed of a conductive material. When the restraint plate is constructed of a conductive material, the restraint plate can have an insulation coating on the surface to insulate it from the current collector plate. The restraint plate may, for example, be made of stainless steel.

### <Bipolar Electrode Laminate>

The one or more bipolar electrode laminate of the present disclosure is included in the electrode laminate modules, and each of the bipolar electrode laminates has a positive electrode current collector layer, a positive electrode active material layer, a solid electrolyte layer or a separator layer, a negative electrode active material layer, and a negative electrode current collector layer in this order. The number of bipolar electrode laminates included in the electrode laminate module is not particularly limited, but may be 1 or greater, 2 or greater, 3 or greater, 5 or greater, 10 or greater, or 20 or greater, and may be 100 or less, 80 or less, 60 or less, 50 or less, or 40 or less.

In the present disclosure, the area of the bipolar electrode laminate in the plane direction is not particularly limited, but may be 0.5 m² or greater, 0.8 m² or greater, 1.0 m² or greater, 1.3 m² or greater, 1.5 m² or greater, or 2.0 m² or greater, and may be 10.0 m² or less, 8.0 m² or less, 6.0 m² or less, or 4.0 m² or less.

### (Positive Electrode Current Collector Layer)

In the present disclosure, a positive electrode current collector layer is included in the bipolar electrode laminate.

Examples of the material of the positive electrode current collector layer include, but are not limited to, aluminum, aluminum alloy, and stainless steel.

The thickness of the positive electrode current collector layer is not particularly limited, but may be 10.0 μm or greater, 30.0 μm or greater, or 40.0 μm or greater, and may be 100.0 μm or less, 80.0 μm or less, or 60.0 μm or less.

A positive electrode current collector layer may also serve as a negative electrode current collector layer, and a negative electrode current collector layer may also serve as a positive electrode current collector layer.

### (Positive Electrode Active Material Layer)

In the present disclosure, the positive electrode active material layer is included in the bipolar electrode laminate.

The positive electrode active material layer of the present disclosure contains a positive electrode active material. In addition, the positive electrode active material layer of the present disclosure may further contain at least one of a dispersion material, a conductive agent, a solid electrolyte, and a binder, if necessary.

In the present disclosure, the thickness of the positive electrode active material layer is not particularly limited, but may be, for example, 0.1 μm or greater, 0.5 μm or greater, 1.0 μm or greater, 3.0 μm or greater, 5.0 μm or greater, or 10.0 μm or greater, and may be 1000.0 μm or less, 700.0 μm or less, 500.0 μm or less, 300.0 μm or less, or 100.0 μm or less.

In the present disclosure, the density of the positive electrode material layer is not particularly limited, but may be 0.5 g/cm³ or greater, 0.7 g/cm³ or greater, 1.0 g/cm³ or greater, 1.5 g/cm³ or greater, or 2.0 g/cm³ or greater, and may be 15.0 g/cm³ or less, 10.0 g/cm³ or less, 8.0 g/cm³ or less, 6.0 g/cm³ or less, or 3.0 g/cm³ or less.

In the present disclosure, the material of the positive electrode active material is not particularly limited. Examples of the positive electrode active material include, but are not limited to, lithium cobalt oxide (LiCoO₂), lithium nickel oxide (LiNiO₂), lithium manganese oxide (LiMn₂O₄), lithium nickel cobalt manganese oxide (NCM:LiCO_{1/3}Ni_{1/3}Mn_{1/3}O₂), and lithium nickel cobalt aluminum oxide (LiNi_{0.8}(CoAl)_{0.2}O₂), and heterogeneous-element-substituted Li—Mn spinel whose composition is described as Li₁₊ₓMn_{2-x-y}M_{y}O₄ (wherein M is one or more metallic elements selected from Al, Mg, Co, Fe, Ni and Zn), and the like.

In the present disclosure, the shape of the positive electrode active material is not particularly limited, and may be, for example, particulate. In case that the positive electrode active material is particulate, the particle diameter D₅₀ of the positive electrode active material may be, for example, 1.0 nm or greater, 5.0 nm or greater, or 10.0 nm or greater, and may be 500.0 μm or less, 100.0 μm or less, 50.0 μm or less, or 30.0 μm or less. It is noted that, in the present disclosure, the particle diameter D₅₀ is a particle diameter (median diameter) at an integrated value of 50% in a particle diameter distribution on a volume basis determined by a laser diffraction/scattering method.

The content rate of the positive electrode active material in the positive electrode active material layer of the present disclosure is not particularly limited, but may be 1.0% by mass or greater, 5.0% by mass or greater, 10.0% by mass or greater, 15.0% by mass or greater, or 20.0% by mass or greater, and may be 50.0% by mass or less, 45.0% by mass or less, 40.0% by mass or less, 35.0% by mass or less, or 30.0% by mass or less.

In the present disclosure, at least one of a dispersion material, a conductive agent, a solid electrolyte, and a binder may be contained in the positive electrode active material layer.

In the present disclosure, as the conductive agent optionally contained in the positive electrode active material layer, one known as a conductive agent for a secondary battery may be used. Examples of the conductive agents include carbon materials such as Ketjenblack (KB), vapor grown carbon fibers (VGCF), acetylene black (AB), carbon nanotubes (CNT), carbon nanofibers (CNF), carbon black, coke, black lead, and the like. The conductive agent may also be a metallic material capable of withstanding the environment in use of the battery. As the conductive agent, only one kind may be used alone, or a combination of two or more kinds may be used. The shape of the conductive agent may be various shapes such as powdery and fibrous.

The content rate of the conductive agent in the positive electrode active material layer of the present disclosure is not particularly limited, but may be 0.1% by mass or greater, 0.5% by mass or greater, 1.0% by mass or greater, 3.0% by mass or greater, or 5.0% by mass or greater, and may be 20.0% by mass or less, 15.0% by mass or less, 10.0% by mass or less, 8.0% by mass or less, or 5.0% by mass or less.

In the present disclosure, as the solid electrolyte optionally contained in the positive electrode active material layer, one known as a solid electrolyte for a secondary battery may be used. Examples of the solid electrolytes include an inorganic solid electrolyte such as a sulfide solid electrolyte, an oxide solid electrolyte, and a halide solid electrolyte, and an organic polymer electrolyte such as a polymer electrolyte. The electrolyte is particularly preferably a sulfide solid electrolyte and an oxide solid electrolyte from the viewpoint of heat resistance. The solid electrolyte may be, for example, particulate. Only one kind of solid electrolyte may be used alone, or two or more kinds thereof may be used in combination.

Examples of the sulfide solid electrolytes include a Li element, an X element (wherein X is at least one of P, As, Sb, Si, Ge, Sn, B, Al, Ga and In), and a solid electrolyte containing an S element. Further, the sulfide solid electrolyte may further contain at least one of an O element and a halogen element. Examples of the halogen elements include F element, Cl element, Br element, and I element. The sulfide solid electrolyte may be glass (amorphous) and may be glass ceramic. Examples of the sulfide solid electrolytes include, but are not limited to, Li₂S—P₂S₅, LiI—Li₂S—P₂S₅, LiI—LiBr—Li₂S—P₂S₅, Li₂S—SiS₂, Li₂S—GeS₂, Li₂S—P₂S₅—GeS₂, for example.

Examples of the oxide solid electrolytes include, but are not limited to, Li₇La₃Zr₂O₁₂, Li₇₋ₓLa₃Zr₁₋ₓNbₓO₁₂, Li₇₋₃ₓLa₃Zr₂AlₓO₁₂, Li₃ₓLa_{2/3-x}TiO₃, Li₁₊ₓAlₓTi₂₋ₓ(PO₄)₃, Li₁₊ₓAlₓGe₂₋ₓ(PO₄)₃, Li₃PO₄, Li₃₊ₓPO₄₋ₓNₓ(LiPON), and the like. The oxide solid electrolyte may be an amorphous or a crystal.

Examples of the halide solid electrolytes include, but are not limited to, NaBH₄, NaB₁₀H₁₀, NaCB₉H₁₀, NaCB₁₁H₁₂, NaB₁₂Cl₁₂, and the like.

Examples of the polymer electrolytes include, but are not limited to, polyethylene oxide (PEO), polypropylene oxide (PPO), and copolymers thereof.

The content rate of solid electrolytes in the positive electrode active material layer of the present disclosure may be 1.0% mass % or greater, 5.0% mass % or greater, 10.0% mass % or greater, 13.0% mass % or greater, or 15.0% mass % or greater, and may be 30.0% mass % or less, 20.0% mass % or less, 15.0% mass % or less, or 10.0% mass % or less.

In the present disclosure, as the binder optionally contained in the positive electrode active material layer, a binder known as a binder used in a secondary battery may be used. Examples of the binders include styrene butadiene rubber (SBR), carboxy methylcellulose (CMC), acrylonitrile butadiene rubber (ABR), butadiene rubber (BR), polyvinylidene fluoride (PVDF), and polytetrafluoroethylene (PTFE). Only one kind of binder may be used alone, or a combination of two or more kinds thereof may be used.

The content rate of the binder in the positive electrode active material layer of the present disclosure is not particularly limited, but may be 0.1% by mass or greater, 0.5% by mass or greater, 1.0% by mass or greater, 3.0% by mass or greater, or 5.0% by mass or greater, and may be 20.0% by mass or less, 15.0% by mass or less, 10.0% by mass or less, 8.0% by mass or less, or 5.0% by mass or less.

### (Solid Electrolyte Layer)

In the present disclosure, a solid electrolyte layer may be included in the bipolar electrode laminate of the present disclosure. The solid electrolyte layer contains at least a solid electrolyte.

The solid electrolyte contained in the solid electrolyte layer of the present disclosure can refer to the above description regarding the positive electrode active material layer of the present disclosure.

### (Separator Layer)

In the present disclosure, a separator layer may be included in the bipolar electrode laminate of the present disclosure.

In the present disclosure, the separator layer may be any separator layer commonly used in an electrode laminate module, and examples thereof include a material made of a resin such as butadiene rubber (BR), polyethylene (PE), polypropylene (PP), polyester, and polyamide. The separator layer may have a single layer structure or a multilayer structure. Examples of the separator layers having a double layer structure include a separator having a two-layer-structure of PE/PP, or a separator having a three-layer-structure of PP/PE/PP or PE/PP/PE and the like. The separator layer may be made of a nonwoven fabric such as a cellulose nonwoven fabric, a resin nonwoven fabric, or a glass fiber nonwoven fabric.

In the present disclosure, the thickness of the separator layer is not particularly limited.

### (Negative Electrode Active Material Layer)

In the present disclosure, the negative electrode active material layer is included in the bipolar electrode laminate.

The negative electrode active material layer of the present disclosure contains a negative electrode active material. In addition, the negative electrode active material layer of the present disclosure may further contain at least one of a dispersion material, a conductive agent, a solid electrolyte, and a binder, if necessary.

In the present disclosure, the material of the negative electrode active material is not particularly limited. The negative electrode active material may be, for example, metal lithium, and may be a material capable of occluding and releasing metal ions such as lithium ions. Examples of the materials capable of occluding and releasing metal ions such as lithium ions include, but are not limited to, an alloy-based negative electrode active material, a carbon material, lithium titanate (Li₄Ti₅O₁₂), silicon carbide (SiC), that is, silicon particles, and the like.

The alloy-based negative electrode active material is not particularly limited, and examples thereof include a Si alloy-based negative electrode active material or a Sn alloy-based negative electrode active material. Si alloy-based negative electrode active material includes silicon, silicon oxide, silicon carbide, silicon nitride, and the like, or a solid solution thereof. Further, Si alloy-based negative electrode active material may include a metal element other than silicon, for example, iron (Fe), cobalt (Co), antimony (Sb), bismuth (Bi), lead (Pb), nickel (Ni), copper (Cu), zinc (Zn), germanium (Ge), indium (In), tin (Sn), titanium (Ti), and the like. Sn alloy-based negative electrode active material includes tin, tin oxide, tin nitride and the like, or a solid solution thereof. Further, Sn alloy-based negative electrode active material may include a metallic element other than tin, for example, iron (Fe), cobalt (Co), antimony (Sb), bismuth (Bi), lead (Pb), nickel (Ni), copper (Cu), zinc (Zn), germanium (Ge), indium (In), titanium (Ti), and the like.

The carbon material is not particularly limited, and examples thereof include hard carbon, soft carbon, graphite, and black lead.

Details of the negative electrode active material, the dispersion material, the conductive agent, the solid electrolyte, and the binder contained in the negative electrode active material layer of the present disclosure, can refer to the above description regarding the positive electrode active material layer of the present disclosure.

### (Negative Electrode Current Collector Layer)

In the present disclosure, the negative electrode current collector layer is included in the bipolar electrode laminate.

Details of the negative electrode current collector layer of the present disclosure can refer to the above description regarding the positive electrode current collector layer of the present disclosure.

### <First and Second Current Collector Plates>

In the present disclosure, the first and second current collector plates are included in the electrode laminate module.

The materials of the current collector plates include, but are not limited to, aluminum, an aluminum alloy, and stainless steel, for example.

<Elastic Body Layer with Metal Foil>

In the present disclosure, an elastic body layer with metal foil is included in the electrode laminate module. The elastic body layer with metal foil of the present disclosure has an elastic body and a metal foil on at least a portion of the upper surface, the lower surface, and the side surface of the elastic body, whereby the metal foil on the upper surface of the elastic body and the metal foil on the lower surface of the elastic body are electrically connected to each other.

In the elastic body layer with metal foil of the present disclosure, all of the upper surface and the lower surface of the elastic body layer with metal foil may have a metal foil.

In the present disclosure, the elastic body may be composed of a plurality of elastic sub-bodies arranged in a plane direction. Thus, even when the electrode laminate module has a large area in the plane direction, it is possible to easily provide the elastic body layer with metal foil.

Further, as in FIG. 2 described above, when the elastic body is composed of a plurality of elastic sub-bodies arranged in the plane direction, the metal foil may enfold a plurality of elastic sub-bodies as a whole, whereby the metal foil on the upper surface of the elastic body and the metal foil on the lower surface of the elastic body may be electrically connected to each other.

### (Elastic Body)

In the present disclosure, an elastic body is included in the elastic body layer with metal foil. The elastic body may be, in particular, an insulating elastic body, for example an insulating elastic body made of rubber.

The thickness of the elastic body is not particularly limited, but may be 10.0 mm or greater, 13.0 mm or greater, 15.0 mm or greater, or 20.0 mm or greater, and may be 50.0 mm or less, 40.0 mm or less, 30.0 mm or less, or 25.0 mm or less.

As described above, when the elastic body is composed of a plurality of elastic sub-bodies, the plurality of elastic sub-bodies may have an engaging portion at an end portion, and the engaging portions of the adjacent elastic sub-bodies may be engaged with each other, whereby the plurality of elastic sub-bodies may be integrated to constitute the elastic body. Thus, when restrained by the restraint member, the elastic body expands in the plane direction, whereby suppressing the formation of wrinkles on the metal foil between the two adjacent elastic sub-bodies. Because of the wrinkles thus formed, a difference in the restraining pressure (surface pressure) in the plane occurs, and thereby, in the negative electrode active material layer of the bipolar electrode laminate, lithium may be deposited.

In the present disclosure, the engaging portion has an uneven portion on the surface, and the uneven portions of the engaging portions of the adjacent elastic sub-bodies may be engaged with each other, whereby the plurality of elastic sub-bodies may be integrated to constitute the elastic body.

The shape of the engaging portion of the present disclosure is not particularly limited, but may be, for example, the uneven shape as shown in FIG. 4. In the embodiment shown in FIG. 4, the uneven shape of the engaging portion 414 of the elastic sub-body is a triangular shape, so that the uneven shape on the end of the two adjacent elastic sub-bodies corresponds, it is arranged in a combined state.

Engaging distance L of the engaging portion of the elastic sub-body is not particularly limited, but may be 1.00 mm or greater, 1.50 mm or greater, 2.00 mm or greater, 3.00 mm or greater, or 5.00 mm or greater, and may be 15.00 mm or less, 13.00 mm or less, 10.00 mm or less, or 8.00 mm or less.

The shape of the surface of the engaging portion is not particularly limited, but may be a shape in which uneven shapes are repeated. At this time, the depth h and the width w of the one uneven shape repeated are not particularly limited. The depth h of uneven shape may be determined in accordance with the thickness of the elastic body, 0.10 mm or greater, 0.20 mm or greater, 0.40 mm or greater, 1.00 mm or greater, 1.50 mm or greater, or 2.00 mm or greater, and may be 10.00 mm or less, 9.00 mm or less, 8.00 mm or less, or 5.00 mm or less. The width w of the uneven shape may be 0.10 mm or greater, 0.20 mm or greater, 0.40 mm or greater, 1.00 mm or greater, 1.50 mm or greater, or 2.00 mm or greater, and may be 10.00 mm or less, 9.00 mm or less, 8.00 mm or less, or 5.00 mm or less.

### (Metal Foil)

In the present disclosure, the elastic body is included in the elastic body layer with metal foil, and the metal foil is arranged on at least a portion of the upper surface, the lower surface, and the side surface of the elastic body.

The materials of the metal foil include, for example, aluminum, aluminum alloy, and stainless steel, but not limited to these cases.

The thickness of the metal foil is not particularly limited, but may be 10.0 μm or greater, 30.0 μm or greater, or 40.0 μm or greater, and may be 100.0 μm or less, 80.0 μm or less, or 60.0 μm or less.

### <Insulating Elastic Body Layer>

In the electrode laminate module of the present disclosure, it is preferable that the interval between the first restraint plate and the first current collector plate and the interval between the second restraint plate and the second current collector plate be insulated. In this case, the insulating elastic body layer can be arranged between the first restraint plate and the first current collector plate and between the second restraint plate and the second current collector plate. Details of the insulating elastic body layer can refer to the description regarding the elastic body of the elastic body layer with metal foil.

### <<Method of Manufacturing a Bipolar Electrode Laminate>>

The method of the present disclosure of manufacturing a bipolar electrode laminate comprises
providing the electrode laminate module described in the present disclosure, and
applying a voltage to the first current collector plate and the second current collector plate to charge or discharge the bipolar electrode laminate.

### <Providing of Electrode Laminate Module>

In the method of the present disclosure of manufacturing a bipolar electrode laminate, the electrode laminate module described in the present disclosure is provided first.

In the method of the present disclosure, details of the electrode laminate module can refer to the above description regarding the electrode laminate module.

### <Charging or Discharging of the Bipolar Electrode Laminate>

In the method of the present disclosure of manufacturing a bipolar electrode laminate, a voltage is then applied to the first current collector plate and the second current collector plate to charge or discharge the bipolar electrode laminate.

Thus, the bipolar electrode laminate can be activated.

The method of the present disclosure may further comprise releasing the restraint by the first and second restraint plates after charging or discharging of the bipolar electrode laminate. Therefore, according to the method of the present disclosure, only initial charging and discharging the bipolar electrode laminate, that is, only charging and discharging in which the volume change such as volume expansion is relatively large, is performed in the electrode laminate module of the present disclosure, and then the electrode laminate module after such initial charging and discharging can be incorporated into the final electrode laminate module. According to this, it is possible to suppress the expansion and contraction of the electrode laminate after the final electrode laminate module is manufactured.

The present disclosure will be described in further detail with reference to the following examples, but the scope of the present disclosure is not limited by these examples.

### EXAMPLES

### Example 1

### <Preparation of a Bipolar Electrode Laminate>

A bipolar electrode laminate in which 30 bipolar electrodes having a positive electrode current collector layer, a positive electrode active material layer, a separator layer, a negative electrode active material layer, and a negative electrode current collector layer in this order, were laminated in series, was prepared. The positive electrode active material layer contained lithium iron phosphate as a positive electrode active material, and the negative electrode active material layer contained black lead as a negative electrode active material. In addition, the bipolar electrode laminate had a width of 1.0 m×a depth of 1.0 m, and an area of 10 m².

### <Preparation of a Electrode Laminate Module>

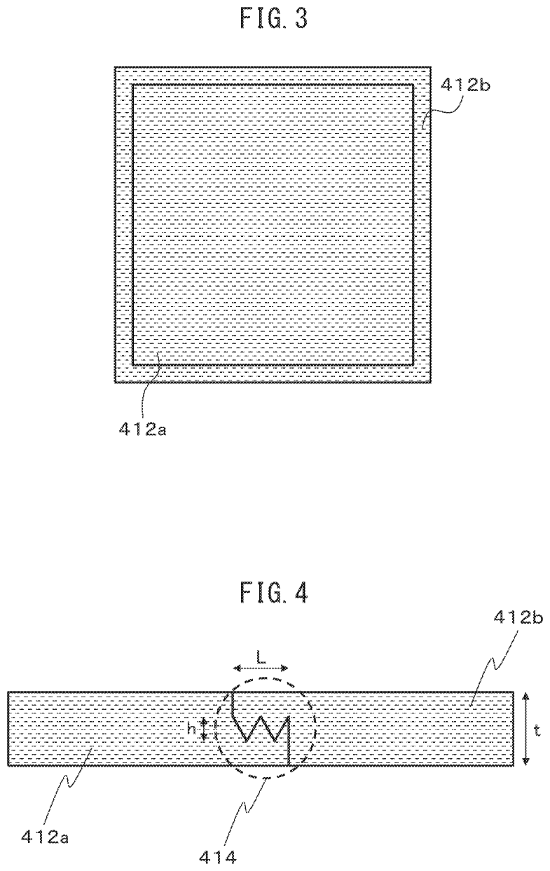

First and second restraint plates, first and second current collector plates, and a metal foil, which are constructed of a material containing aluminum, were prepared. Further, as elastic sub-bodies, foam materials of Young's modulus 400 kPa were prepared, the elastic sub-bodies plurality were arranged in the plane direction, and a metal foil was arranged on the upper surface, the lower surface and the side surface of the elastic sub-bodies, to produce an elastic body layer with metal foil. At this time, when viewed from the laminating direction, the elastic sub-bodies of the insulating elastic body layer and the elastic body layer with metal foil were arranged as shown in FIG. 3. The thickness t of the elastic body layer at this time was 15.0 mm.

The first restraint plate, the insulating elastic body layer, the first current collector plate, the elastic body layer with metal foil, the bipolar electrode laminate, the elastic body layer with metal foil, the second current collector plate, the insulating elastic body layer, and the second restraint plate are laminated in this order. Thereafter, using a bolt, by restraining the first and second restraint plates in the laminating direction, to produce an electrode laminate module. At this time, the restraining load P was 40 kPa. Further, it was confirmed that in the electrode laminate module of Example 1, an interval between the first and second restraint plates was electrically connected.

### <Surface Pressure Evaluation>

Computer Aided Engineering (CAE) was used to analyze the surface pressure of the elastic body layers. Among the plurality of elastic sub-bodies constituting the elastic body layer, on two elastic sub-bodies (hereinafter, referred to as first and second elastic sub-bodies) and at the boundary of the first and second elastic sub-bodies, the surface pressure was determined.

### Example 2

An electrode laminate module of Example 2 was manufactured in the same manner as in Example 1, except that a plurality of elastic sub-bodies had an engaging portion at its end. It was confirmed that in electrode laminate module of Example 2, an interval between the first and second restraint plate was electrically connected. Details of the engaging portions are described below.

A view of two adjacent elastic sub-bodies from the side direction are shown in FIG. 4. A plurality of uneven shapes whose cross sections are equilateral triangles is arranged in the engaging portions on the end portion of the elastic sub-bodies, and two adjacent elastic sub-bodies are arranged in a state where the respective engaging portions of the two elastic sub-bodies are combined to each other. At this time, the thickness of the engaging portion in the combined state was 15.0 mm and the same as the thickness of the elastic body layers.

The depth h of the uneven shape should be larger than the maximum value of the compressive deformation amount so that the gap between the engaging portions of the two elastic sub-bodies does not occur. Therefore, the depth h of the uneven shape, based on the compressive deformation Δt generated by the elastic body being compressed, as the safety factor k of 1.50, was defined as a value calculated by the following equation.

(Compressive deformation amount Δt)=(thickness t of elastic body layer)×(restraining load P)/(Young's modulus of elastic body)=15.0 [mm]×40 [kPa]/400 [kPa]=1.5 [mm]

(depth h of uneven shape)=(safety factor k)×(compressive deformation amount Δt)=1.50×1.5 [mm]=2.25 [mm]

The width w of the uneven shape was defined as a value calculated by the following equation.

(width w of uneven shape)=(depth h of uneven shape)×2/√3=2.25 [mm]×2/√3=2.60 [mm]

Engaging distance L, based on the compression deformation Δt generated by the elastic body being compressed, as the safety factor k of 3.00, was defined as a value calculated by the following equation.

(Engaging distance L)=(Compressive deformation amount Δt)×(Safety factor k)=1.5 [mm]×3.00=4.50 [mm]

### <<Evaluation>>

Evaluation results of the electrode laminate modules of Example 1 and Example 2 are shown in Table 1 below.

TABLE 1

| | | Surface pressure evaluation [MPa] | | |
|---|---|---|---|---|
| | | | The boundary | |
| | | | of the first and | |
| | Engaging | First elastic | second elastic | Second elastic |
| | portion | sub-bodies | sub-bodies | sub-bodies |
| Example 1 | Without | 0.07 | 0.018 | 0.072 |
| Example 2 | With | 0.07 | 0.066 | 0.072 |

As is apparent from Table 1 above, as compared with Example 1 in which the end portions of the elastic sub-bodies did not have the engaging portions, in Example 2 in which the end portions of the elastic sub-bodies had the engaging portions, the surface pressure between the plurality of elastic sub-bodies was large. From the above, the electrical connection by using the elastic body with metal foil can be confirmed, and also, it has been confirmed that when the elastic body is composed of a plurality of elastic sub-bodies and the end portions of the elastic sub-bodies have engaging portions, a difference in the surface pressure in the plane of the elastic body layer can be suppressed.

### REFERENCE SIGNS LIST

100 Electrode laminate module
200 Bipolar electrode laminate
300 Restraint plate
400 Elastic body layer with metal foil
410 Insulating elastic body layer
412 Elastic sub-body
412a First elastic sub-body
412b Second elastic sub-body
414 Engaging portion
420 Metal foil
500 Current collector plate
600 Restraint member

1. An electrode laminate module,
wherein a first restraint plate, a first current collector plate, one or more bipolar electrode laminates, a second current collector plate, and a second restraint plate are laminated in this order,
wherein between the first current collector plate and the bipolar electrode laminate, between two of the bipolar electrode laminates adjacent, and/or between the bipolar electrode laminate and the second current collector plate, an elastic body layer with metal foil is laminated,
wherein, by means of the first and second restraint plates, the first and second current collector plates, the one or more bipolar electrode laminates, and the elastic body layer are restrained in the laminating direction,
wherein the bipolar electrode laminate has a positive electrode current collector layer, a positive electrode active material layer, a solid electrolyte layer or a separator layer, a negative electrode active material layer, and a negative electrode current collector layer in this order, and
wherein the elastic body layer has an elastic body and a metal foil on at least a portion of the upper surface, the lower surface, and the side surface of the elastic body, whereby the metal foil on the upper surface of the elastic body and the metal foil on the lower surface of the elastic body are electrically connected to each other.

2. The electrode laminate module according to claim 1,
wherein the elastic body is composed of a plurality of elastic sub-bodies arranged in a plane direction, and
wherein the metal foil enfolds the plurality of elastic sub-bodies as a whole, whereby the metal foil on the upper surface of the elastic body and the metal foil on the lower surface of the elastic body are electrically connected to each other.

3. The electrode laminate module according to claim 2,
wherein the plurality of elastic sub-bodies has an engaging portion at an end portion, and
wherein the engaging portions of the adjacent elastic sub-bodies are engaged with each other, whereby the plurality of elastic sub-bodies is integrated to constitute the elastic body.

4. The electrode laminate module according to claim 3,
wherein the engaging portion has an uneven portion on the surface, and
wherein the uneven portions of the engaging portions of the adjacent elastic sub-bodies are engaged with each other, whereby the plurality of elastic sub-bodies is integrated to constitute the elastic body.

5. A method of manufacturing a bipolar electrode laminate, wherein the method comprises:
providing the electrode laminate module of claim 1, and
applying a voltage to the first current collector plate and the second current collector plate to charge or discharge the bipolar electrode laminate.
